(19) United States
(12) Patent Application Publication
(10) Pub. No.: US 2025/0114874 A1
(43) Pub. Date: Apr. 10, 2025

(54) METHOD FOR INSERTING A LASER BEAM OF A LASER CUTTING MACHINE INTO A PLATE-LIKE WORKPIECE FOR CUTTING OUT A WORKPIECE PART FROM THE WORKPIECE ALONG A PREDETERMINED CUTTING CONTOUR ON THE WORKPIECE DESCRIPTION

(71) Applicant: TRUMPF Werkzeugmaschinen SE + Co. KG, Ditzingen (DE)

(72) Inventor: Frederick Struckmeier, Heimsheim (DE)

(21) Appl. No.: 18/985,119

(22) Filed: Dec. 18, 2024

Related U.S. Application Data
(63) Continuation of application No. PCT/EP2023/066502, filed on Jun. 19, 2023.

(30) Foreign Application Priority Data
Jun. 23, 2022 (DE) 10 2022 115 643.5

(51) Int. Cl. B23K 26/38; B23K 37/04

(52) U.S. Cl. CPC B23K 26/38; B23K 37/0408

(57) ABSTRACT

A method for inserting a laser beam of a laser cutting machine into a plate-like workpiece for cutting out a workpiece part from the workpiece along a predetermined cutting contour on the workpiece is provided. The workpiece rests on a workpiece support having a plurality of supporting regions. Relative positions of the supporting regions in relation to the workpiece are known. The method includes assigning predefined surface regions on the workpiece to the supporting regions based on the known relative positions, and selecting a damage-free insertion point for inserting the laser beam into the workpiece for cutting out the workpiece part. A position of the insertion point lies outside the predefined surface regions such that the laser beam does not pierce any of the supporting regions.

### CROSS REFERENCE TO RELATED APPLICATIONS

This application is a continuation of International Application No. PCT/EP2023/066502 (WO 2023/247461 A1), filed on Jun. 19, 2023, and claims benefit to German Patent Application No. DE 10 2022 115 643.5, filed on Jun. 23, 2022. The aforementioned applications are hereby incorporated by reference herein.

### FIELD

Embodiments of the present invention relate to a method for inserting a laser beam of a laser cutting machine into a plate-like workpiece for cutting out a workpiece part from the workpiece along a predetermined cutting contour on the workpiece, and to a laser cutting machine.

### BACKGROUND

A method for inserting a laser beam of a laser cutting machine into a plate-like workpiece for cutting out a workpiece part from the workpiece along a predetermined cutting contour on the workpiece is known, for example, from DE102018126077A1, which shows a method for laser cutting, in which the position of a workpiece sheet relative to support webs of a workpiece support is determined and the position of support tips of the support webs is calculated. Support spaces above the support tips and support surrounding spaces are defined, in which a comparison is made with programmed contour lines and insertion points. Depending on the result of the comparison, a nesting of the workpiece parts to be cut is optimized in a control program for the cutting process, i.e., the position of contours/workpiece parts to be cut is shifted on the workpiece sheet in order to prevent cutting contours or insertion points from being located exactly on web tips, which would result in damage to the web tips by the laser beam.

The well-known method reliably prevents damage to the workpiece support. However, the method is complex because the nesting must be optimized towards a further restriction. There are also other restrictions, such as minimizing waste of the remaining workpiece, which must also be taken into account, and therefore optimization with multiple restrictions is challenging. It is difficult to provide a nesting that optimally meets all restrictions, for example, which completely prevents any damage to the support webs and at the same time allows for minimal waste of the remaining workpiece, although these are just two of many possible other restrictions.

### SUMMARY

Embodiments of the present invention provide a method for inserting a laser beam of a laser cutting machine into a plate-like workpiece for cutting out a workpiece part from the workpiece along a predetermined cutting contour on the workpiece. The workpiece rests on a workpiece support having a plurality of supporting regions. Relative positions of the supporting regions in relation to the workpiece are known. The method includes assigning predefined surface regions on the workpiece to the supporting regions based on the known relative positions, and selecting a damage-free insertion point for inserting the laser beam into the workpiece for cutting out the workpiece part. A position of the insertion point lies outside the predefined surface regions such that the laser beam does not pierce any of the supporting regions.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a perspective view of a laser cutting machine according to an exemplary embodiment of the invention;

FIG. 2 shows a perspective view of a support web of a workpiece support of the laser cutting machine of FIG. 1 according to some embodiments;

FIG. 3 shows a schematic view of a main body of the laser cutting machine of FIG. 1 according to some embodiments;

FIG. 4 shows a schematic view of a method according to an exemplary embodiment of the invention for laser cutting workpiece parts from a plate-like workpiece by means of the laser cutting machine of FIG. 1; and

FIG. 5 shows a schematic top view of a workpiece to be machined with supporting regions and predefined surface regions according to some embodiments.

### DETAILED DESCRIPTION

Embodiments of the invention provide a method which is improved in relation to the prior art, which reliably prevents damage during laser cutting of workpiece parts from a plate-like workpiece in a simple manner and with as few restrictions as possible.

According to some embodiments, a method for inserting a laser beam of a laser cutting machine into a plate-like workpiece for cutting out a workpiece part from the workpiece along a predetermined cutting contour on the workpiece is provided, wherein the workpiece rests on a workpiece support having a plurality of supporting regions and the relative positions of the supporting regions in relation to the workpiece are known (or determined). Predefined surface regions on the workpiece are (or will be) assigned to the supporting regions on the basis of the known relative positions. In addition, a damage-free insertion point for inserting the laser beam into the workpiece for cutting out the workpiece part is selected, the position of which insertion point lies outside the predefined surface regions such that the laser beam does not pierce any of the supporting regions.

The method according to embodiments of the invention selects an insertion point for inserting the laser beam into the workpiece before actually cutting the workpiece part therefrom, which or whose position is not located in the supporting regions of the workpiece support, so that they cannot be damaged by the insertion. This insertion point is referred to herein as the damage-free insertion point. The surface regions are predefined by the known relative position of the workpiece in relation to the supporting regions of the workpiece support or vice versa, where damage to the workpiece support can occur during insertion. Since insertion into supporting regions requires a great deal of energy and time, the method according to embodiments of the invention not only prevents damage to the workpiece support, but also saves time and energy. By aligning the relative position of the workpiece in relation to the supporting regions and the insertion point, it is possible to avoid the need to laboriously change a nesting plan to the position of the workpiece on the supporting regions.

The method only refers to one workpiece part on the workpiece. Typically, however, a large number of workpiece parts are cut out of one workpiece. The method can accordingly be applied to a plurality of or all workpiece parts of a workpiece, whereby a damage-free insertion point is selected for each of the workpiece parts.

Insertion points are points into which the laser beam is inserted in order to trace the cutting contour and thus the workpiece part in the workpiece. The insertion is therefore part of the cutting process, which, however, precedes the actual cutting out of the workpiece part from the workpiece. The insertion points can be located outside the actual cutting contour. The insertion points can approach the cutting contour of the workpiece part in a predefined path or a cutting start point, in particular in an arcuate path or an arcuate cutting start point.

The fact that the insertion point is selected means in particular that its position on the workpiece is chosen or determined. The position of the insertion point, for example, can be freely selected or chosen from predefined insertion points, as will be explained in more detail later.

In the present case, a plate-like workpiece is understood to mean in particular a workpiece plate or workpiece sheet which has its greatest extent in a horizontal plane and is arranged with a thickness in the vertical plane orthogonal thereto. Such a workpiece sheet can in particular be a workpiece panel. Workpiece parts are cut out of such a workpiece sheet (hereinafter also referred to as “workpiece”) by means of laser cutting. It can be provided that the workpiece parts remain connected to the workpiece by one or a plurality of predetermined breaking points, from which they can then be released. Such a predetermined breaking point can be designed in particular in the form of a web between the workpiece part and the workpiece or a remaining workpiece.

The laser cutting machine for laser cutting the workpieces can in particular be a flatbed machine tool, i.e., a laser cutting flatbed machine tool, in particular a two-dimensional laser flatbed machine. The flatbed machine tool can also be a combination machine that can carry out further separating processes and/or further processing steps such as deburring, bending, folding, welding, drilling, thread cutting, etc. The laser cutting machine cuts out the workpiece parts, the shape of which is predetermined to the laser cutting machine, from the workpiece or the remaining workpiece by means of laser cutting. The cutting contours can be predetermined according to a nesting plan, which can be predetermined, for example, by a control device of the laser cutting machine. Then a corresponding laser processing head of the laser cutting machine moves the laser beam along the predetermined cutting contours.

The relative positions of the supporting regions in relation to the workpiece are known in the method. Of course, the method according to embodiments of the invention can comprise a previous step of detecting the relative positions of the supporting regions in relation to the workpieces. The geometry or arrangement of the supporting regions relative to one another can be known, since it is typically rigid and does not move. However, the position of a workpiece on the workpiece support and thus the supporting regions can change. How the detection of a workpiece in relation to the workpiece support can be carried out, for example by sensor detection, will be explained in more detail later using examples.

The workpiece support can, for example, comprise a pallet or the like. The workpiece support can also have a plurality of support webs. In particular, the support webs can run parallel to one another. On the support webs, the supporting regions can be arranged along the support webs. The supporting regions can in particular be support elevations, especially in the form of support tips. The workpiece can rest on the supporting regions of the support webs at defined distances between the supporting regions of the same support web and different support webs. The support webs can, for example, be part of the pallet, be arranged on the pallet or between an edge of the pallet and be firmly connected to the laser cutting machine, in particular a pallet changer thereof. The supporting regions can provide a point-like or preferably flat support area for the workpiece. The support elevations, in particular support tips, especially having a flat support area for the workpiece, can be formed by serrated sections on the support webs, whereby each serrated section forms a support elevation. Accordingly, it is now possible to protect the supporting regions, in particular the support tips of the support webs, from damage and wear. Accordingly, only the supporting regions, in particular support tips, can be taken into account for the predefinition of the surface regions. This improves the quality of the workpiece parts because undamaged support tips always enable the same positionally accurate support and thus the relative position of the workpiece in relation to the workpiece support. It also avoids having to replace the support webs, making the process cost-effective.

It can be advantageous if two insertion points for the workpiece part are (or will be) predefined in a nesting plan of the laser cutting machine and the damage-free insertion point is selected from the two predefined insertion points by comparing the predefined insertion points with the predefined surface regions. This means that the nesting planning does not have to take into account the coincidence of insertion points and supporting regions. Instead, only two insertion points are defined in the nesting plan. The nesting plan indicates the so-called nesting or distribution of the workpiece parts on the workpiece and thus the cutting contours and the insertion points.

It is preferred if the two insertion points are predetermined with a predefined insertion point distance from one another in a workpiece plane of the workpiece, wherein the predefined insertion point distance is selected such that at most one of the two insertion points falls in one of the predefined surface regions with a known geometry of the supporting regions in the workpiece plane. This ensures that one of the two insertion points for a workpiece part, which is provided according to the nesting plan, can always be used for damage-free insertion by the laser beam. For this purpose, the geometry of the supporting regions must be known. Geometry refers in particular to the arrangement and/or size of the supporting regions in the workpiece plane.

For this purpose, the insertion point distance in a first extension direction of the workpiece plane, along which the supporting regions are spaced apart from one another, can be different from a supporting region distance between each two supporting regions.

For this purpose, the supporting regions can also be arranged on support webs of the workpiece support, wherein the support webs are arranged parallel to one another in a second extension direction of the workpiece plane running perpendicular to the first extension direction, and the insertion point distance in the second extension direction is different from a support web distance between each two support webs.

Finally, it can also be provided that the insertion point distance in the first extension direction is also greater than a length of the surface regions in the first extension direction and/or the insertion point distance in the second extension direction is also greater than a length of the surface regions in the second extension direction.

Preferably, the predefined surface regions are larger in area than the supporting regions. The advantage of this is that damage to the area of the workpiece support surrounding the supporting region, especially to the flanks of the support tips of the support webs, can be easily prevented.

It is advantageous if the predefined surface regions are round. This is an advantageous geometry of the surface regions because it can ensure a high degree of freedom from damage around a peripheral area around the supporting regions. A diameter of at least 5 mm, at least 6 mm or at least 7 mm of the round surface regions has proven to be advantageous.

It is also advantageous if the relative positions of the supporting regions in relation to the workpiece are predetermined by at least one stop for the workpiece. This stop can be located, for example, on the workpiece support itself and/or on a pallet for the workpiece. A plurality of stops can also be provided. This ensures that the workpiece is always in a defined position in relation to the workpiece support. The stop can also be used for improved sensory determination of the relative position and/or for a double determination of the relative position.

Alternatively or additionally, the relative positions of the supporting regions in relation to the workpiece are determined by measuring the workpiece and/or the workpiece support, in particular at least one reference element on the workpiece support. Since the geometry of the workpiece support, in particular the arrangement of the supporting regions relative to one another, is known, measuring the workpiece in relation to the reference element of the workpiece support may be sufficient. The measurement can be carried out by one or a plurality of sensors and/or one or a plurality of cameras. The relative position of the workpiece support, in particular the relative positions of the supporting regions, can be determined in a simple manner, for example during operation. The measurement can be carried out, for example, using a sensor system of the laser cutting machine, in particular a capacitive distance sensor system for detecting the distance between the laser processing head of the laser cutting machine and the workpiece. In general, at least one subgroup of the support webs and/or web tips can be detected and, optionally, the positions of non-detected support webs and/or web tips can be calculated by interpolation.

Other possible measurement options are based, for example, on optical sensors that are based on at least one of the following methods: image processing method based on an area image recording, a laser light section method, a strip light projection method, a light field camera, a 3D camera, e.g., a time-of-flight (TOF) camera, in particular for detecting the distance and/or depth of web depressions, the determination of the state of the geometric shape for a concurrent assessment of the wear of a support web and/or a support tip, and/or on an ultrasonic sensor system, which uses ultrasonic sensors in particular on a cutting head of the flatbed machine tool.

The object mentioned at the outset is further achieved by a laser cutting machine according to claim 11. The laser cutting machine is equipped with a workpiece support for supporting a workpiece thereon, a laser processing head for emitting a laser beam, and a control device for selecting an insertion point for inserting the laser beam, wherein the laser cutting machine is configured to carry out the method according to embodiments of the invention.

In this case, features described herein with respect to the method according to embodiments of the invention also apply with respect to the laser cutting machine and vice versa.

The method according to embodiments of the invention can be controlled in particular by appropriate control of the laser cutting machine by the control device. The control device can have a memory on which a computer program is stored, which is executed by a CPU of the control device in order to carry out the method according to embodiments of the invention on the laser cutting machine. The control device or the computer program selects the insertion point or predetermines its position on the workpiece. Of course, the control device can also perform other tasks, such as measuring the relative positions, planning the nesting of the workpiece parts on the workpiece, controlling the cutting of the workpiece part out of the workpiece, etc.

Exemplary embodiments of the invention are described and explained in more detail below.

In the following description and the figures, the same reference signs are used in each case for identical or corresponding features.

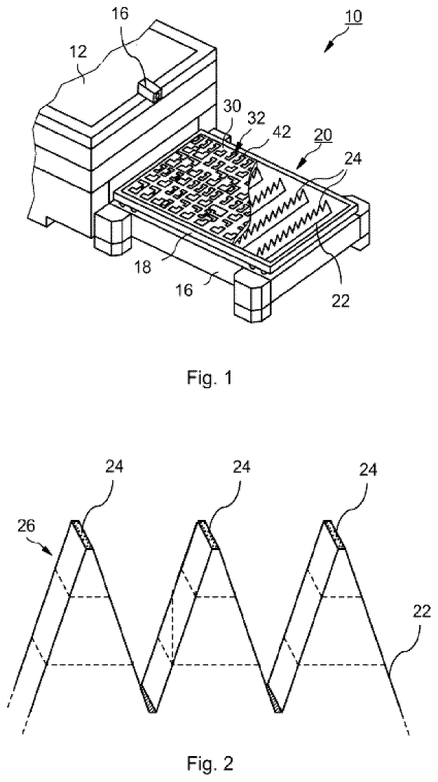

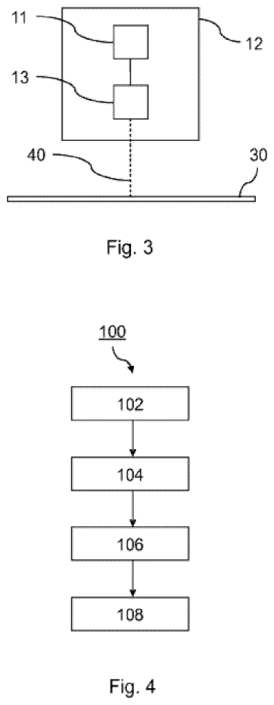

FIG. 1 shows a laser cutting machine 10 in the form of a laser cutting flatbed machine tool with a main housing 12 in which a laser cutting process is carried out with a laser beam 40 (see FIG. 3). In particular, a focus of the laser beam 40 is guided by a control device 11 (see FIG. 3) along predetermined cutting contours 42 arranged in a machining region over a plate-like workpiece 30, in particular a metal sheet extending substantially two-dimensionally, in order to cut out workpiece parts 30 with specific shapes predetermined according to a nesting plan.

The laser cutting machine 10 also comprises a pallet changer 14. The pallet changer 14 is designed to position one or a plurality of pallets 18 during production. A workpiece 30 to be cut (as a raw or starting material), in particular a workpiece sheet, can be placed and stored on a pallet 18 and introduced into the main housing 12 for the laser cutting process. After the cutting process is completed, the pallet 18 can be moved out of the main housing 12 with a cut workpiece 30, as shown in FIG. 1, so that the cut workpiece parts 32 can be sorted from the remaining workpiece 30.

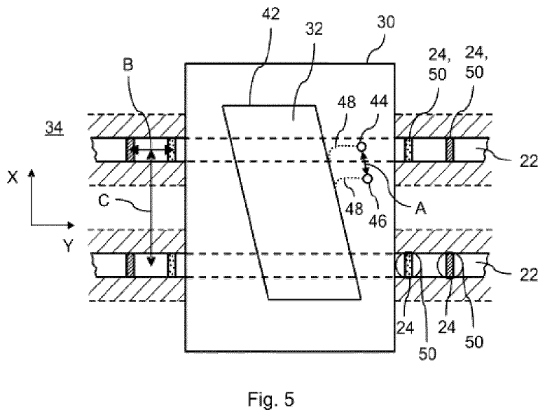

FIG. 3 shows the laser cutting process in the main housing 12. The laser processing head 13, which emits the laser beam 40 for cutting out the workpiece parts 32 from the workpiece 30 onto the workpiece 30, can be freely positioned in the machining region so that the laser beam 40 can be guided substantially along any two-dimensional cutting contours over the workpiece 30 to be cut. In this case, a cutting contour 42 for the laser beam 40 is predetermined in the control device 11 based on a nesting plan in order to cut out the workpiece parts 32 from the workpiece 30. The nesting plan indicates the arrangement of the individual workpiece parts 32 in the workpiece 30, as shown in FIG. 1. In addition, the nesting plan includes the predetermination of insertion points 44, 46 and predetermined cutting start points 48 for inserting the laser beam 40 and guiding the laser beam along the cutting start point 48 to the cutting contour 42 (see FIG. 5).

During laser cutting, the laser beam 40 heats the metal of the workpiece 30 along the predetermined cutting contours 42 until it melts. A gas jet, usually nitrogen or oxygen, usually exits the laser processing head 13 in the area of the laser beam 40 and pushes the molten material of the workpiece 30 downwards and out of the gap that is formed. The workpiece 30 is thus completely severed by the laser beam 40 during cutting.

To cut out a workpiece part 32, the laser beam 40 is moved along the predetermined cutting contours 42 of the respective workpiece 32. This begins at one of the insertion points 44, 46, which lie outside the workpiece 30, and then approaches the contour of the workpiece 30, in particular in an arcuate cutting start point 48.

In the exemplary embodiment shown, the pallet 18 has a workpiece support 20. The workpiece support 20 has a plurality of support webs 22 which run transversely, in particular perpendicularly, to the direction of insertion of the workpiece 30 into the main housing 12 and are aligned parallel to one another.

A part of a support web 22 is shown in perspective in FIG. 2. For example, the support webs 22 have a distance of 20 mm to 100 mm from one another. The support webs 22 form supporting regions 24 on which the workpiece 30 is placed or supported. The supporting regions 24 usually form grid points which can have a distance of, for example, 5 mm to 50 mm along the support webs 22, wherein a support web 22 can have a thickness of, for example, 1 mm to 5 mm. The supporting regions 24 thus form a grid of areas that can influence the cutting process of the workpiece 30 lying on them. The regions of the support webs 22 that influence the cutting process can also extend to regions that directly adjoin the supporting regions 24 that are in contact with the workpiece 30, e.g., the flanks of the support webs 22 that lead to the supporting regions 24. As shown, the supporting regions 24 here are tips of repeating serrated sections 26 of the support webs 22.

FIG. 1 also shows a camera 16 of the laser cutting system 10, which is arranged, for example, on the main housing 12. The camera 16 can be designed, among other things, for capturing images of the pallet 18, the support webs 22 and supporting regions 24 as well as the relative position of the workpiece 30 with respect to the pallet 18 (and possibly the support webs 22 and supporting regions 24) and is connected to an image evaluation unit of the control device 11. Consequently, the control device 11 can at least determine the relative position of the workpiece 30 in relation to the supporting regions 24 or the relative positions of the supporting regions 24 in relation to the workpiece 30. The arrangement of the supporting regions 24 is already known due to their geometry. It is therefore sufficient to detect the relative position of the workpiece 30 in relation to a reference element (not shown), in particular on the workpiece support 20. The control device 11 can predefine these supporting regions 24 as surface regions 50, as shown in FIG. 5, or define enlarged surface regions 50, in particular round surface regions 50, around the supporting regions 24, as is also shown purely by way of example for the surface regions 50 of the support web 22 shown at the bottom of FIG. 5.

By means of the laser cutting system 10, as explained with reference to FIGS. 1 to 3, the method 100 shown schematically in FIG. 4 is now carried out. In a first method step 102, the relative positions of the workpiece 30 in relation to the supporting regions 24 are determined, as described above. In a second method step 104, the surface regions 50 are defined based on the supporting regions 24. The surface regions 50 comprise at least the regions in which the workpiece 30 rests on the supporting regions 24, preferably also an adjacent region in which the flanks of the support webs 22 branch off from the supporting regions 24.

Subsequently, in a third method step 106, one of two predefined insertion points 44, 46 is selected based on a comparison of the predefined insertion points 44, 46 with the predefined surface regions 50. In this case, the insertion point 44, 46 which is arranged outside the predefined surface regions is selected as the damage-free insertion point 44, 46 and the laser beam 40 is inserted into its position. This can prevent the support webs 22 from being damaged at their supporting regions 24 by the laser beam 40.

In the fourth method step 108 of the method 100, the workpiece parts 32 are finally cut out of the workpiece 30 along the predetermined cutting contours 42, wherein the laser beam 40, after inserting into the damage-free insertion point 44, 46, passes via the cutting start point 48 to the cutting contour 42 and travels along it in order to cut out the workpiece part 32.

FIG. 5 shows a schematic top view of a workpiece 30 with a highly simplified nesting plan, in which only one workpiece part 32 is available or considered for cutting out, which also has an exemplary simple rectangular geometry. The workpiece 30 and the workpiece support 20 are viewed here in a common workpiece plane 34, in which the workpiece 30 rests on the workpiece support 20, i.e., directly in contact with one another.

The supporting regions 24, in particular support tips, of the support webs 22 of the workpiece support 20 are located below the workpiece 30. The surfaces of the supporting regions 24 are predefined as the surface regions 50 as described above. A cutting contour 42 for cutting out the workpiece part 32 from the workpiece 30 is predetermined along two surface regions 50.

In FIG. 5, the two previously mentioned insertion points 44, 46 are now shown, which are predefined for insertion according to the nesting plan in the control device 11. The two insertion points 44, 46 are located at a predefined insertion point distance A from one another. In a first extension direction Y in the workpiece plane 34, the insertion point distance A is smaller than a supporting region distance B between neighboring supporting regions 24 in the first extension direction Y. At the same time, the insertion point distance A in the first extension direction Y is greater than a length of the surface regions 50 in the first extension direction Y. In addition, the insertion point distance A in a second extension direction X perpendicular to the first extension direction Y on the workpiece plane 34 is smaller than a support web distance C between neighboring support webs 22 in the second extension direction X. At the same time, the insertion point distance A in the second extension direction X is greater than a length of the surface regions 50 in the second extension direction X.

The above-mentioned selection of the insertion point distance A between each two insertion points 44, 46 in the first extension direction Y and in the second extension direction X in the nesting plan ensures that at least one of the two predefined insertion points 44, 46 of a workpiece part 34 is always located outside the predefined surface regions 50 and can be selected as a damage-free insertion point 44, 46.

In FIG. 5, for example, the predefined insertion point 44 is located in the workpiece plane 34 above the support web 22. Because of the workpiece 30, it is not visible that the insertion point 44 is actually located on a predefined surface region 50 or a supporting region 24. Consequently, this insertion point 44 cannot be selected without avoiding damage to the supporting region 24. However, due to the selected insertion point distance A, the predefined insertion point 46 is arranged outside the predefined surface regions 50, as can be seen from FIG. 5. Consequently, the insertion point 46 is a damage-free insertion point 46 through which the laser beam 40 can be inserted into the workpiece 30, can be moved along its cutting start point 48 to the cutting contour 42 and can travel along the cutting contour 42 in order to cut out the workpiece part 32 from the workpiece 30.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for inserting a laser beam of a laser cutting machine into a plate-like workpiece for cutting out a workpiece part from the workpiece along a predetermined cutting contour on the workpiece, wherein the workpiece rests on a workpiece support having a plurality of supporting regions and relative positions of the supporting regions in relation to the workpiece are known, the method comprising:
assigning predefined surface regions on the workpiece to the supporting regions based on the known relative positions, and
selecting a damage-free insertion point for inserting the laser beam into the workpiece for cutting out the workpiece part, wherein a position of the insertion point lies outside the predefined surface regions such that the laser beam does not pierce any of the supporting regions.

2. The method according to claim 1, wherein two predefined insertion points for the workpiece part are predefined in a nesting plan of the laser cutting machine, and the damage-free insertion point is selected from the two predefined insertion points by comparing the two predefined insertion points with the predefined surface regions.

3. The method according to claim 2, wherein the two predefined insertion points are predefined with a predefined insertion point distance from one another in a workpiece plane of the workpiece, wherein the predefined insertion point distance is selected such that at most one of the two predefined insertion points falls in one of the predefined surface regions with a known geometry of the supporting regions in the workpiece plane.

4. The method according to claim 3, wherein the insertion point distance in a first extension direction of the workpiece plane, along which the supporting regions are spaced apart from one another, is different from a supporting region distance between each two supporting regions.

5. The method according to claim 4, wherein the supporting regions are arranged on support webs of the workpiece support, wherein the support webs are arranged parallel to one another in a second extension direction of the workpiece plane running perpendicular to the first extension direction, and the insertion point distance in the second extension direction is different from a support web distance between each two support webs.

6. The method according to claim 5, wherein the insertion point distance in the first extension direction is greater than a first length of the surface regions in the first extension direction, and/or the insertion point distance in the second extension direction is greater than a second length of the surface regions in the second extension direction.

7. The method according to claim 1, wherein the predefined surface regions are larger in area than the supporting regions.

8. The method according to claim 6, wherein the predefined surface regions are round.

9. The method according to claim 1, wherein the relative positions of the supporting regions in relation to the workpiece are predetermined by at least one stop for the workpiece.

10. The method according to claim 1, wherein the relative positions of the supporting regions in relation to the workpiece are determined by measuring the workpiece and/or the workpiece support.

11. A laser cutting machine comprising a workpiece support for supporting a workpiece thereon, a laser processing head for emitting a laser beam, and a control device for selecting an insertion point for inserting the laser beam, wherein the laser cutting machine is configured to carry out the method according to claim 1.
